(19) United States
(12) Patent Application Publication
(10) Pub. No.: US 2007/0062786 A1
(43) Pub. Date: Mar. 22, 2007

(54) Supporting organ for an axially moving body

(75) Inventors: Gabriel Lodewijks, Emmer-Compascuum (NL); Karel Frederik Drenth, Gouda (NL)

Correspondence Address: AKERMAN SENTERFITT, P.O. BOX 3188, WEST PALM BEACH, FL, 33402-3188, US

(73) Assignee: Technische Universiteit Delft, Delft (NL)

(21) Appl. No.: 10/551,328

(22) PCT Filed: Mar. 18, 2004
(86) PCT No.: PCT/NL04/00192

§ 371 Date: Jul. 7, 2006

(30) Foreign Application Priority Data
Mar. 31, 2003 (NL) 1023050

(51) Int. Cl. B65G 39/10

(52) U.S. Cl. 198/842

(57) ABSTRACT

A supporting body (1) for an axially moving body such as a conveyor belt, a cable or a stepless escalator, comprising a roller (3) rotatable about a shaft (2) for the support of the body and at least a first support (4) in which the shaft of the roller is mounted for carrying the roller, wherein a second support is provided, wherein the first support and the second support (5) are designed to cooperate in carrying the roller, wherein the second support is fixedly mounted and the first support can, in the moving body's direction of movement, be fixedly coupled with the second support, while in a plane perpendicular to this direction of movement, the first support is rotatable about a pivoting point located on a contact surface shared by the roller and the body to be supported by the roller.

The invention relates to a supporting body for an axially moving body such as a conveyor belt, a cable or a stepless escalator, comprising a roller rotatable about a shaft for the support of the body and at least a first support in which the shaft of the roller is mounted for carrying the roller.

Such a supporting organ is known from practice and, as already mentioned, is used with conveyor belts, cables and stepless escalators. Conveyor belts of the kind referred to may be in use, for example, as travellators at airports or elsewhere, or as conveyor belts for freight. Supermarket checkout systems also employ conveyor belts using support organs of the kind to which the invention relates.

A problem with these applications is that the shaft of such rollers that support but are not driven, is fixed in relation to the surroundings. As a consequence, there is not always an optimal contact surface between the roller and the body, e.g. the conveyor belt supported by the roller, so that slip may occur as well as excessive wear to belt and roller.

The object of the invention is to find a solution to this problem.

To this end the support organ according to the invention is characterised in that a second support is provided, wherein the first support and the second support are designed to cooperate in carrying the roller, wherein the second support is fixedly mounted and the first support can, in the moving body's direction of movement, be fixedly coupled with the second support, while in a plane perpendicular to this direction of movement, the first support is rotatable about a pivoting point located on a contact surface shared by the roller and the body to be supported by the roller.

In a further aspect, the supporting organ according to the invention may be advantageously realised such that the first support and the second support possess intermating slots and pins, wherein the slots have a curve, which is determined for each slot individually by an imaginary centre and a radius relating to said centre of said slot, such that the centres of all the slots located in the same vertical plane coincide, forming the pivoting point of the first support. This solution is very elegant, because in this construction the load on the roller from the body to be supported brings about an interplay of forces, which causes the first support to assume a position in which the roller provides optimal support for the body.

In a preferred embodiment of the invention, the supporting organ is characterised in that there are curved slots, one or more of which are located above a rotational axis of the roller and one or more of which are located below the rotational axis of the roller, and in that the radii of said slots possess a common central point located on the bearing surface of the top side of the roller.

Hereinafter the invention will be further elucidated by way of the drawing of a non-limiting exemplary embodiment of the supporting organs according to the invention.

The drawing shows in:

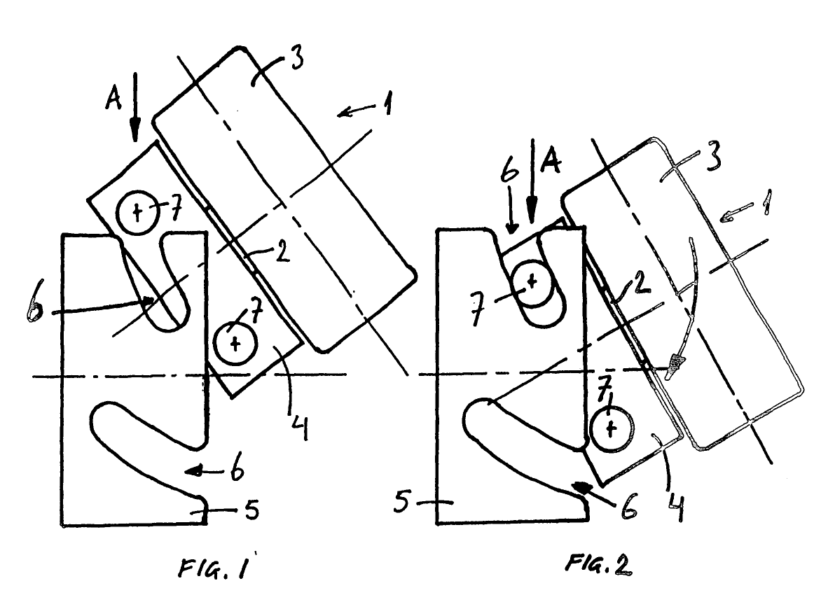

FIG. 1 to FIG. 3 a series of steps for mounting the supporting organ according to the invention;

FIG. 4 the supporting organ according to the invention in the mounted condition without load; and

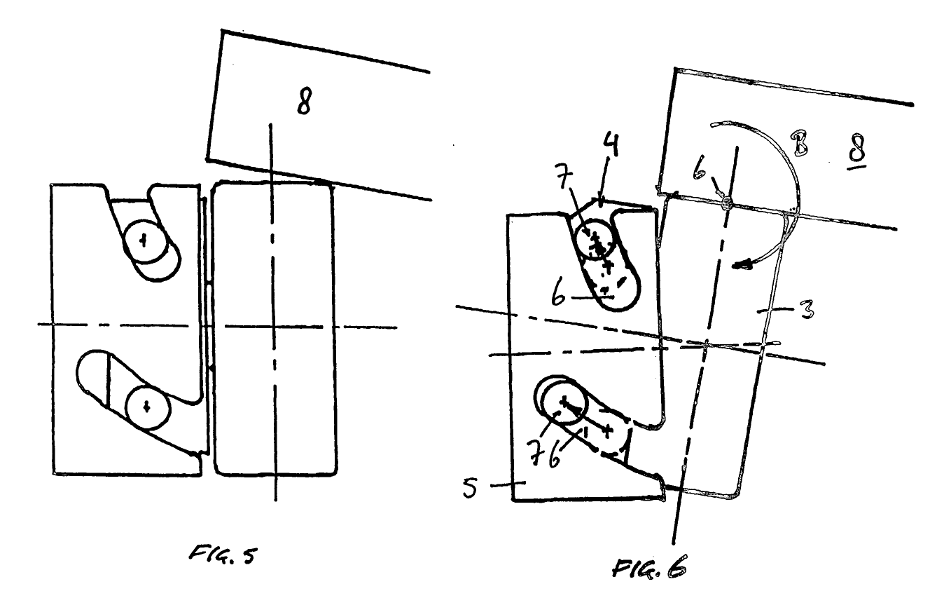

FIGS. 5 and 6, the supporting member according to the invention when loaded.

Similar parts in the figures carry identical reference numbers.

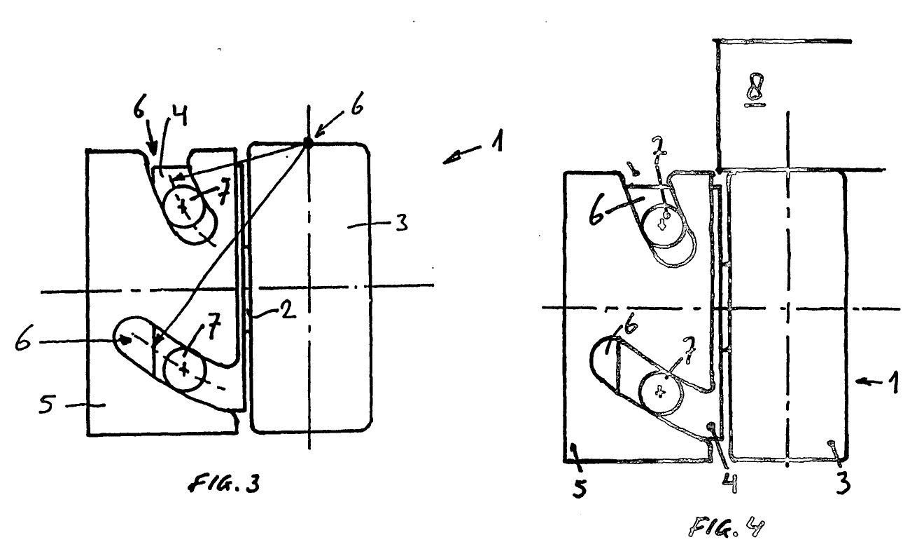

Referring first to FIG. 3, the same shows a supporting organ 1 according to the invention. This supporting organ 1 comprises a roller 3 rotatable about an axis 2 for the support of a body (not shown). This body may be a conveyor belt or a cable or a stepless escalator or another such body. The direction of conveyance of the body is perpendicular to the plane of the drawing, that is to say the roller 3 also rotates in the direction of conveyance of the body to be supported.

The supporting organ 1 further comprises a first support 4; this is clearly shown in the FIGS. 1 and 2. The shaft 2 of the roller 3 is mounted in this first support 4 so that the first support 4 can carry the roller 3.

The first support 4 cooperates with a second support 5, which as a rule is mounted on solid ground so as to render it fixed.

The first support 4 can be coupled with the second support 5 in such a manner that the first support 4 is fixed also, but will exhibit this condition only in the moving body's direction of conveyance, that is to say in the direction perpendicular to the plane of the drawing. In the plane of the drawing, i.e. in the plane perpendicular to the body's direction of conveyance, the first support is mounted to be rotatable about a pivoting point 6 located on a contact surface shared by the roller 3 and the body to be supported by the roller 3.

As clearly shown in the FIGS. 1 to 3, the first support 4 and the second support 5 are embodied with intermating slots 6 and pins 7. The slots 6 have a curve, which is determined for each slot individually by an imaginary centre 6 and a radius relating to said centre 6 of said slot, such that the centres of all the slots 6 in the same vertical plane coincide and form the pivoting point 6 of the first support 4.

The Figures further clearly show that the curved slots 6 are distributed such that one or several of them are located above the rotational axis of the roller 3 and also one or several slots 6 are located below the rotational axis of the roller 3.

FIGS. 1 to 3 demonstrate that mounting the supporting organ 1 according to the invention may be extremely simple. FIG. 1 shows that the assembly of roller 3 and first support 4 are first moved downward in the direction of arrow A such as to insert a pin 7 of the first support 4 into a slot 6 of the second support 5.

Next, FIG. 2 shows that the downward movement in the direction of arrow A can be continued whereby the upper pin of the first support 4 finds the lowest point of the upper slot 6 of the second support 5, and the lower pin 7 of the first support 4 can be inserted into the second support 6, which is the slot 6 located at the underside of said second support 5.

Next, FIG. 3 shows the supporting organ 1 in the mounted condition, which corresponds to the unloaded position of the supporting organ 1 as shown in FIG. 4. This FIG. 4 also shows a conveyor belt 8 supported by the roller 3.

FIG. 5 shows a greatly exaggerated situation arising when the load exerted by belt 8 is increased. As a result of the interplay of forces then occurring, the assembly of roller 3 and first support 4 rotates about the fixed point of rotation 6 in the direction of arrow B, as shown in FIG. 6. The two pins 7 that are mounted on the first support 4 then move upwards into the slots 6 of the second support 5, thereby finding a new point of equilibrium, where the roller provides optimal support for the belt 8.

Although the inventors believe that the above given exemplary embodiment presents an optimal form of the manner in which the invention may be applied, the invention is not limited to this specific exemplary embodiment. In the context of this patent application, the elucidated exemplary embodiment serves exclusively as explanation for the appended claims, while the claims must not be deemed to necessarily be limited to said given exemplary embodiment. Modifications fulfilling the essence of the invention as established by said claims, possibly supplemented by the specification and the drawings and/or the grant file, are explicitly considered to fall within the protective scope of the claims.

1. A supporting body for an axially moving body such as a conveyor belt, a cable or a stepless escalator, comprising a roller rotatable about a shaft for the support of the body and at least a first support in which the shaft of the roller is mounted for carrying the roller, characterised in that a second support is provided, wherein the first support and the second support are designed to cooperate in carrying the roller, wherein the second support is fixedly mounted and the first support can, in the moving body's direction of movement, be fixedly coupled with the second support, while in a plane perpendicular to this direction of movement, the first support is rotatable about a pivoting point located on a contact surface shared by the roller and the body to be supported by the roller.

2. A supporting body according to claim 1, characterised in that first support and the second support possess intermating slots and pins, wherein the slots have a curve, which is determined for each slot individually by an imaginary centre and a radius relating to said centre of said slot, such that the centres of all the slots located in the same vertical plane coincide, forming the pivoting point of the first support.

3. A supporting body according to claim 2, characterised in that there are curved slots, one or more of which are located above a rotational axis of the roller and one or more of which are located below the rotational axis of the roller, and in that the radii of said slots possess a common central point located on the bearing surface of the top side of the roller.
